(19) United States
(12) Patent Application Publication
(10) Pub. No.: US 2012/0202671 A1
(43) Pub. Date: Aug. 9, 2012

(54) FOLDING MACHINE HAVING A DEVICE FOR TRIMMING FOLDED EDGES AND METHOD OF FOLDING SHEETS

(75) Inventor: MARTIN HAUPT-TERLAU, ERDMANNHAUSEN (DE)

(73) Assignee: HEIDELBERGER DRUCKMASCHINEN AG, HEIDELBERG (DE)

(21) Appl. No.: 13/367,531

(22) Filed: Feb. 7, 2012

Related U.S. Application Data
(60) Provisional application No. 61/443,515, filed on Feb. 16, 2011.

(30) Foreign Application Priority Data
Feb. 7, 2011 (DE) 10 2011 010 515.8

(51) Int. Cl. B31F 1/00

(52) U.S. Cl. 493/419

(57) ABSTRACT

A folding machine for folding sheet-like elements includes at least a first buckle-folding station, a second buckle-folding station and possibly a further buckle-folding station, for respectively forming folding configurations having at least one fold. A folded edge trimming device is provided upstream of a respective folding station, for removing the at least one previously-formed fold. A method of folding using such a folding machine is also provided. It is thus possible to generate folded products with a high level of folding accuracy.

### CROSS-REFERENCE TO RELATED APPLICATION

This application claims the priority, under 35 U.S.C. §119, of German Patent Application DE 10 2011 010 515.8, filed Feb. 7, 2011 and U.S. Provisional Patent Application No. 61/443,515, filed Feb. 16, 2011; the prior applications are herewith incorporated by reference in their entirety.

### BACKGROUND OF THE INVENTION

1. Field of the Invention

The invention relates to a folding machine for folding sheet-like elements, in particular sheets of paper, having at least a first buckle-folding station and a second folding station, in particular a buckle-folding station, for respectively forming a folding configuration having at least one fold. The invention also relates to a method of folding sheet-shaped elements of a first format, in particular in a folding machine according to the invention.

2. Description of the Related Art

The prior art discloses buckle-folding machines and knife-folding machines. A combination of buckle-folding machines and knife-folding machines is commonly known in the form of a combination folding machine. In that case, parallel folds are made in buckle folders and cross folds are made in the following knife folders. The sheet, in its direction of passage through the combination folding machine, passes through at least the following stations: feeder, transfer table, buckle folder, knife folder and delivery device.

The construction of a buckle-folding machine having a multiplicity of buckle folders can be gathered from German Published Patent Application DE 10 2004 041 471 A1. A respective buckle folder in that case includes a buckle plate and three folding rollers, which are disposed in two folding-roller pairs. German Published Patent Application DE 29 40 360 A1 discloses an individual knife folder for folding printed and prefolded sheets. Buckle folders and knife folders are combined in combination folding machines. In that case, parallel folds are made in a first folding station in buckle folders and cross folds are made in a following folding station in knife folders. German Published Patent Application DE 10 2006 055 301 A1 discloses combination folding machines having a plurality of buckle folders and knife folders disposed downstream.

The folded edges of parallel folds, which are produced in a first folding station, stabilize the sheet longitudinally in relation to the fold and thus constitute one or two stabilizing lines. If cross folds are to be generated in a following, further folding station, that is made difficult by the stabilizing lines and it is no longer possible for the sheet to be folded in a defined manner transversely to the stabilizing line or the stabilizing lines. An additional difficulty arises if the sheet has a folded edge only on one side, and has, in contrast, open, non-folded edges on the other side. For those reasons, there is a risk of the cross folds not being at right angles to the preceding parallel folds and not being made precisely at the envisaged locations.

In order to prevent that, for fold-preparation purposes, the prior art makes use of blade-shaft pairs which provide perforations or grooves in the folding line. That is intended to simplify the operation of making the cross folds and to predetermine the position thereof.

European Patent Application EP 1 475 334 A1, corresponding to U.S. Pat. No. 6,902,520, discloses a folding machine having such a blade-shaft pair. In order for it to be possible for folded paper sheets to be provided with perforations or grooves perpendicularly to a folding line, i.e. in the sheet-running direction, blade-shaft pairs are disposed upstream and/or downstream of the folding rollers of a folder. Those blade-shaft pairs are ones in which one blade shaft is fitted with tools and the other blade shaft is fitted with mating tools. A further fold-preparation method can be gathered from German Patent DE 32 76 13.

However, the result is often interaction between the folding preparation provided by the blade shafts and the actual folding operation, which is caused by imprecise adjustment of the folding lengths, a shift in the folding lengths due to a change in the machine speed, upstream folding defects with consequently incorrect fold preparation, etc. That interaction is evident in the generated fold and the prepared folding line (grooving, perforations) deviating from one another, i.e. in low-quality folded products.

### SUMMARY OF THE INVENTION

It is accordingly an object of the invention to provide a folding machine having a device for trimming folded edges and a method of folding sheets, which overcome the hereinafore-mentioned disadvantages and solve the above-described problems of the heretofore-known machines and methods of this general type and which at least improve the production of high-quality folded products.

With the foregoing and other objects in view there is provided, in accordance with the invention, a folding machine for folding sheet-like elements, comprising at least a first buckle-folding station and a second folding station, which is also configured, in particular, as a buckle-folding station, for respectively forming a folding configuration having at least one fold. According to the invention, a device for trimming folded edges is provided upstream of the second folding station, e.g. in the entry region of the folding station or in the region of a transfer table disposed upstream of the folding station, that is to say between the first and second folding stations, for the purpose of removing the at least one fold formed beforehand in the first buckle-folding station, and therefore the signature generated in the first buckle-folding station, prior to entering into the second folding station, is split into a plurality of individual sheets located one above the other, which is referred to herein below as a stack. This ensures that the at least one fold, i.e. the at least one folded edge, which constitutes a stabilizing line of the signature, is removed. It is thus advantageously possible to fold stacks of individual sheets in the second folding station, which makes it possible to produce high-quality folded products.

In accordance with another advantageous feature of the folding machine of the invention, the folding machine has at least one further folding station, which is likewise configured, in particular, as a buckle-folding station. This further folding station serves for forming a folding configuration with at least one fold. A device for trimming folded edges is provided in each case upstream of the at least one further folding station, for the purpose of removing the at least one fold formed beforehand, as a result of which the following processing is simplified. In other words, any further folding station is assigned a trimming device.

In accordance with a further advantageous feature of the invention, a respective device for trimming folded edges has a trimming mechanism, which may be configured as a circular blade, paper cutter, immobile blade cutting edge, cutting die, fluid-jet cutting head or laser cutting head. If the trimming mechanisms used are circular blades, then these can be mounted on the known blade shafts. This variant is thus distinguished by straightforward implementation.

In accordance with an added feature of the invention, the at least one trimming mechanism can advantageously be displaced transversely to the transporting direction of the sheet-like elements, since this therefore allows adjustment of the at least one trimming mechanism to the position of the at least one fold irrespective of the sheet format.

In accordance with an additional particularly advantageous and thus preferred feature of the folding machine of the invention, the device for trimming folded edges has a fixing device for the defined transportation of the sheet-like elements during removal of the at least one fold formed beforehand and during entrance into the following folding station. The fixing device in this case may include, for example, holding-down balls, guide rollers or suction-air assisted guide elements.

In accordance with yet another advantageous feature of the invention, the folding machine has a suction-extraction device for the purpose of removing portions of the sheet-like elements which are generated by the device for trimming folded edges, i.e. for the reliable removal of waste. This ensures that neither the portions themselves nor the paper dust generated during cutting contaminate transporting devices of the folding machine or folding stations. Instead of the suction-extraction device, it is also possible, as an alternative, to use concentrated blowing air.

In accordance with yet a further feature of the invention, a variant provides servomotors for adjusting folding lengths and/or spacings between folding rollers of the buckle-folding stations. The servomotors in this case are connected to a central machine-control device, and therefore folding lengths and/or spacings between folding rollers can be adjusted automatically, on the basis of stored adjustment data. This gives rise to significant time saving as far as adjusting the machine is concerned. Since only individual sheets can be folded in the folding stations according to the invention, it is often the case that such automatic preliminary adjustment is sufficient, with there no longer being any need for time-consuming, stepwise follow-up adjustment of stops and folding rollers by the machine operator.

With the objects of the invention in view, there is also provided a method of folding sheet-like elements of a first format, in particular in a folding machine like that described above. In a first step, a first folded product, a so-called signature, is generated by forming a folding configuration with at least one fold in a first buckle-folding station. In a second step, the at least one fold is removed, in order to thus generate a plurality of sheet-like elements of a second, smaller format located one above the other. This plurality of individual sheets located one above the other is referred to herein below as a stack. In the next step, this stack of sheet-like elements is transported further to a second folding station, which may be configured, in particular, as a buckle-folding station. In this folding station, a second folded product, i.e. a signature of smaller format, is then generated by forming a folding configuration with at least one fold. The at least one fold is a so-called cross fold, i.e. the at least one fold is orthogonal to the at least one fold generated in the first buckle-folding station.

In accordance with another advantageous mode of the method of the invention, if this signature is still to be processed further, then it is possible, in a next step, for the at least one fold formed beforehand likewise to be removed in order to form a stack of sheet-like elements of a further, smaller format, whereupon the stack of sheet-like elements is transported further to at least one further folding station. In the latter, a further folded product can then be generated by forming a folding configuration with at least one fold, wherein the at least one fold is orthogonal to the at least one fold generated in the preceding folding station.

In accordance with an added advantageous mode of the method of the invention, the method may be supplemented by a further step, that is to say by the operation of binding the sheet-like elements to form a brochure, for example by adhesive binding, block stitching, spiral binding, gang stitching, etc. It may be necessary in this case, if appropriate, to remove the at least one fold formed beforehand. This at least one fold may be removed in this case prior to, or following, the operation of binding the sheet-like elements to form a brochure.

In accordance with an additional advantageous feature of the folding machine according to the invention, a device for applying adhesive to the product is disposed upstream of at least one folding station, or integrated in the folding station.

In accordance with yet another advantageous feature of the folding machine according to the invention, a device for trimming the products is disposed downstream of the at least one folding station. The device for applying adhesive and the device for trimming the products advantageously make it possible to produce small books, so-called booklets, from the sheets.

In accordance with a concomitant advantageous feature of the folding machine according to the invention, a device for pressing the products is disposed downstream of the at least one folding station. Pressing the product advantageously makes it possible to prevent the product from bowing.

Other features which are considered as characteristic for the invention are set forth in the appended claims, noting that the invention described herein and the advantageous developments of the invention described herein, even in any desired combination with one another, constitute advantageous developments of the invention.

Although the invention is illustrated and described herein as embodied in a folding machine having a device for trimming folded edges and a method of folding sheets, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, top-plan view of a folding machine according to the invention having a device for trimming folded edges;

FIG. 2 is an enlarged, fragmentary, longitudinal-sectional view of the trimming device;

FIG. 3A is a plan view of a folding sheet;

FIG. 3B is a top-plan view illustrating an operation for trimming the folded sheet of FIG. 3A;

FIG. 4A is a side-elevational view of a zigzag-folded sheet;

FIG. 4B is a top-plan view illustrating an operation for trimming the folded sheet of FIG. 4A;

FIG. 4C is a side-elevational view showing the result of the trimming operation of FIG. 4B;

FIG. 4D is a perspective view showing further processing to form a brochure;

FIG. 4E is a perspective view showing further processing to form a booklet;

FIG. 5 is a top-plan view of a folding machine having three buckle folders and a final transporting table disposed downstream;

FIG. 6 is an enlarged, side-elevational view of an automatic buckle-folding station with a laser-trimming device disposed upstream; and

FIG. 7 is a top-plan view of a folding machine having an adhesive-applying device in the buckle-folding station.

### DESCRIPTION OF THE INVENTION

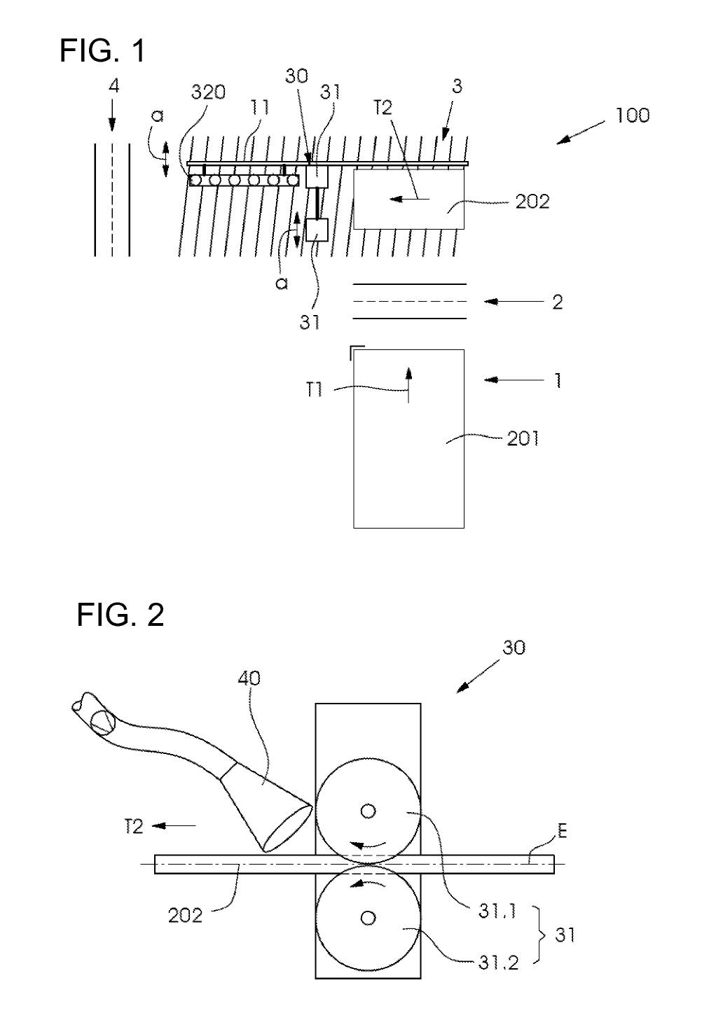

Referring now to the figures of the drawings in detail and first, particularly, to FIG. 1 thereof, there is seen a diagrammatic, plan view of a folding machine 100. The folding machine 100 has a sheet feeder 1, through the use of which sheets 201 are fed in a first transporting direction T1 to a first buckle-folding station 2. In the first buckle-folding station 2, a sheet 201 is zigzag-folded three times, to produce a folded product in the form of a signature 202. This signature 202 is fed over a transporting table 3, in a second transporting direction T2 (which is at right angles to the first transporting direction T1), to a second buckle-folding station 4, in which the signature 202 can be folded further. The transporting table 3 has a guide rule 11. A device 30 for trimming folded edges is disposed upstream of the second folder 4. As a result, the folded product 202 is divided again into four individual sheets located one upon the other. Of course, the number of folds carried out is only an example and can be varied as desired.

In order to provide for adaptation to the format of the folded product 202, the guide rule 11 can be displaced transversely to the transporting direction T2, as is also indicated by a double arrow a. The trimming device 30 can likewise be displaced in the direction a. The device 30 may be coupled, for example, to the rule 11.

According to the embodiment illustrated in FIG. 1, the trimming device 30 has two parallel trimming mechanisms 31, which may be configured, for example, as circular-blade pairs 31. As is illustrated in FIG. 1, the left-hand blade pair 31 has been adjusted to the left-hand edge of the folded product 202 and the right-hand blade pair 31 has been adjusted to the right-hand edge of the folded product 202, as seen in the transporting direction T2. The trimming mechanisms 31 thus make it possible to remove the folded edges generated beforehand in the first folding station 2. All that is therefore necessary in the following, second folding station 4 is for individual sheets located one above the other to be folded, i.e. a stack or block is folded.

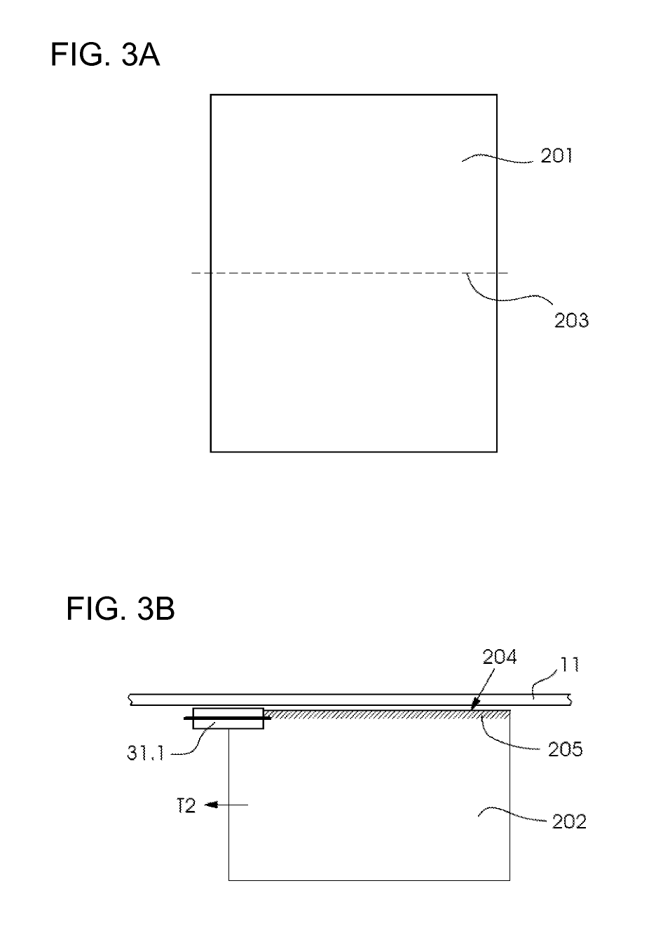

FIG. 2 illustrates a possible trimming device 30 in more detail. The device 30 has a blade-shaft pair 31 with an upper blade 31.1 and a mating lower blade 31.2. At least one of the blades 31.1 and 31.2 has a cutting edge. The blades 31.1 and 31.2 in this case can be driven in opposite directions. A respective folded product 202 is moved along a transporting plane E of the transporting table 3, in the transporting direction T2, between the blades 31.1 and 31.2. The folded product 202 in this case has its previously generated folded edges trimmed. The trimmings and any dust which may arise are reliably disposed of by a suction-extraction device 40.

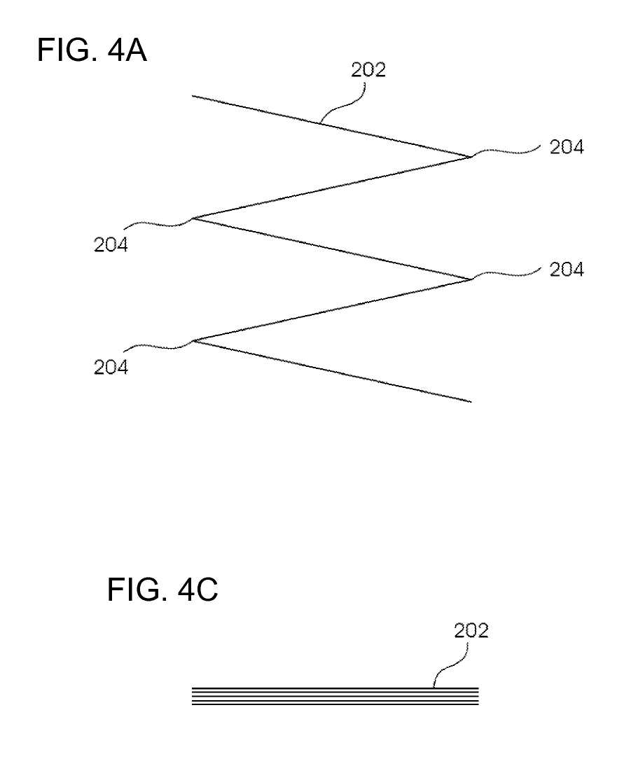

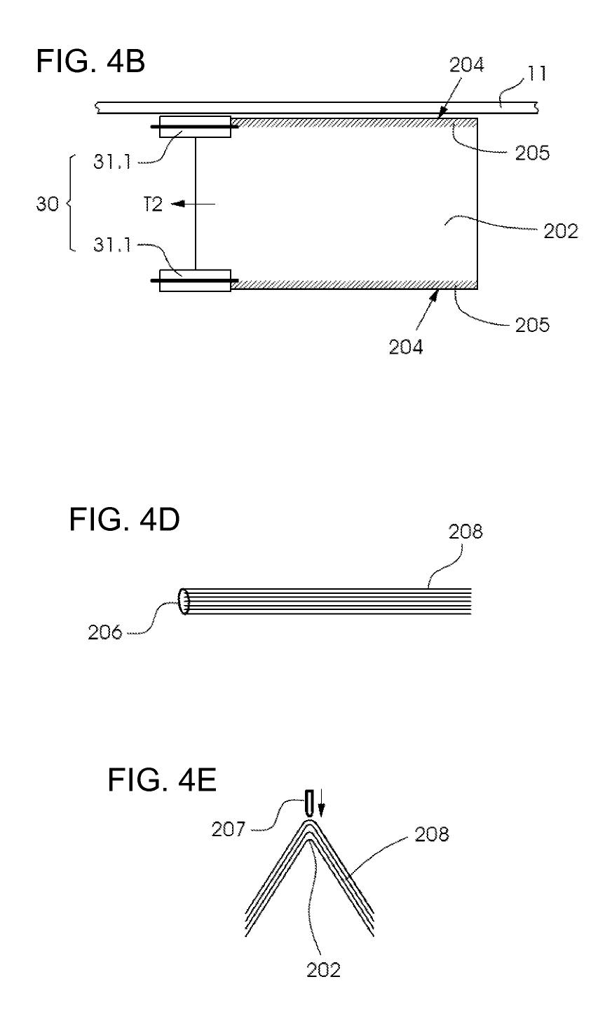

FIGS. 3A and 3B as well as FIGS. 4A and 4B depict the functioning of the trimming device 30. FIG. 3A illustrates a sheet 201 which is folded once, centrally, along a folding line 203. This gives rise to a folded product 202, as is illustrated in FIG. 3B. A folded edge 204 produced during folding butts against the guide rule 11 of the transporting table 3 as the folded product 202 is transported further in the direction T2. The device 30 for trimming folded edges in this case is disposed in such a way that the trimming mechanisms 31 act right alongside the folded edge 204 and cause this folded edge 204 to be cut off. As is indicated by hatching, a region 205 of the folded product 202 which is removed is limited to the folded edge 204 and the immediately adjacent region of the folded product 202. This trimming generates individual sheets located one above the other.

FIG. 4A shows a folded product 202 with a plurality of folds. The folds or folded edges 204 are located one above the other. Such folds are usually referred to as a zigzag fold or concertina fold. A folding-machine configuration as is illustrated in FIG. 1 can be used in order to make it possible to trim such a folded product 202 in the region of the folded edges 204. As can be gathered from the fragmentary view of FIG. 4B, a device for trimming folded edges 30 is used which has two parallel trimming mechanism 31. The right-hand trimming mechanism 31, as seen in the transporting direction T2, acts on the right-hand folded edge 204, as already described above. The left-hand trimming mechanism 31 has been adjusted to the left-hand outer edge of the folded product 202 in order for it likewise to be possible to cut off the left-hand folded edge 204, as seen in the transporting direction T2. The folded product 202 thus has regions 205 which undergo trimming and each include the folded edges 204 and the immediately adjacent region.

FIG. 4C illustrates the result of trimming, which is that the folded product 202 includes 5 individual sheets located one above the other.

FIGS. 4D and 4E illustrate possible ways of processing the folded products 202 further. These folded products may be processed further, for example, by having an adhesive or an adhesive strip 206 applied to form an adhesively bound brochure 208. As an alternative, a further fold can be made and then binding can take place using staples 207.

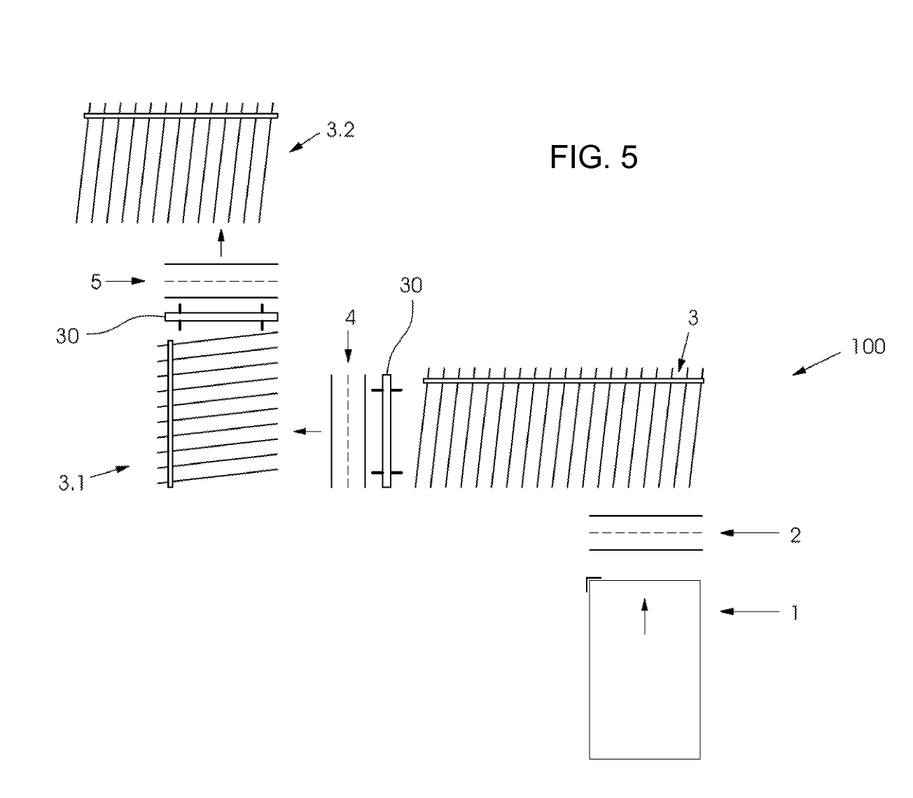

FIG. 5 illustrates a configuration of a folding machine 100 which has first, second and third buckle-folding stations 2, 4, 5. A first transporting table 3 is disposed between the first buckle-folding station 2 and the second buckle-folding station 4. A second transporting table 3.1 is disposed between the second buckle-folding station 4 and the third buckle-folding station 5. A third or final transporting table 3.2 is disposed, as a product-delivery device (e.g. an imbricated-sheet delivery device), following the third, and thus final, buckle-folding station 5. The transporting direction in the region of a respective transporting table 3, 3.1, 3.2 in each case is at right angles to the transporting direction in the preceding buckle-folding station 2, 4, 5. The transporting tables 3, 3.1 and 3.2 each have trimming devices 30, as have already been described above.

Due to the use of the devices 30 for trimming folded edges, which are respectively disposed upstream of the second folding station 4 and the third folding station 5, the folding stations 4, 5 only have to be used in each case for folding stacked individual sheets.

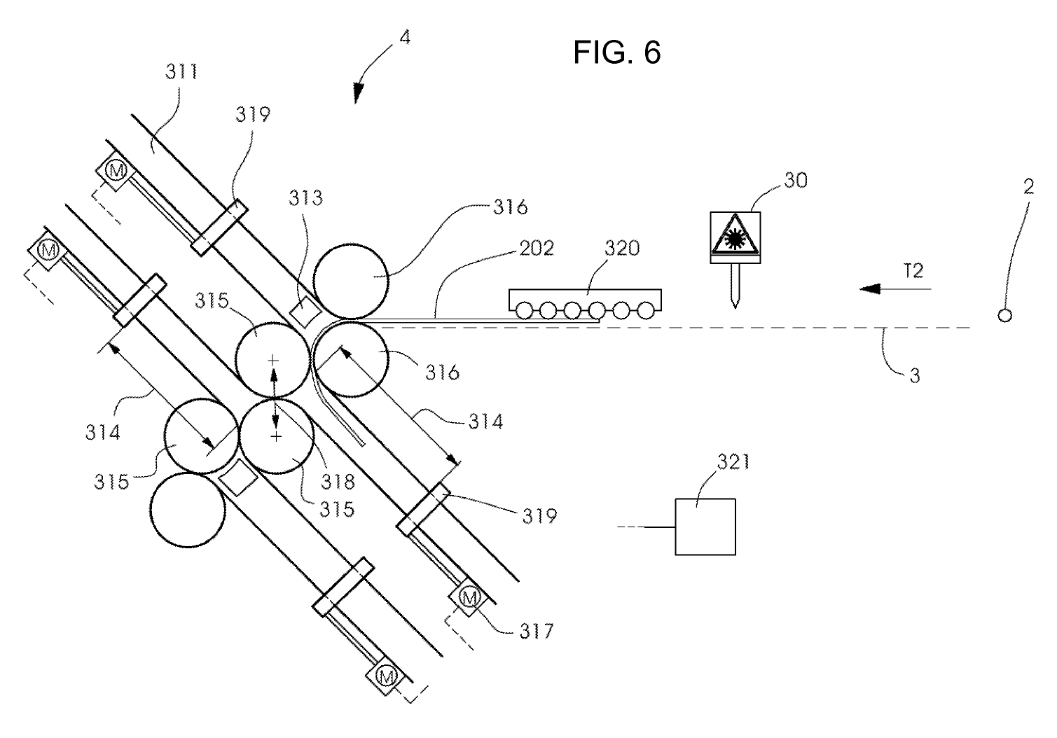

FIG. 6 illustrates how sheets 202 coming from a first buckle-folding station 2 are fed over a feed table 3 having a transporting belt, in a transporting direction T2, to the second buckle-folding station 4. Processing in this case takes place through the use of the trimming device 30, which is illustrated herein as a laser unit or, as an alternative, by a fluid-jet unit. A following fixing device 320 ensures reliable further transportation. The stacked sheets 202 have already been transported past a first, upper buckle plate 311 into a second, lower buckle plate 311. A sheet diverter 313 in this case prevents entry into the first buckle plate 311. A stop 319 of the buckle plate 311 constitutes a leading-edge stop and has been adjusted to an entry length (folding length) 314. If the sheets 202 strike against the leading-edge stop 319 by way of their leading edge, the sheets 202 are braked. The sheets 202 then curve convexly and are folded by folding rollers 315, 316, before they enter into the following buckle plate 311 and are folded further.

As indicated, the effective folding length 314 of the buckle plates 311 can be adjusted through the use of adjusting motors 317. The adjusting motors 317 in this case are advantageously connected to a machine-control device 321, in which adjustment data are stored. It is also possible for a spacing 318 between the respective rollers 315, 316 to be motor-adjustable. This allows the adjusting operations to be automated.

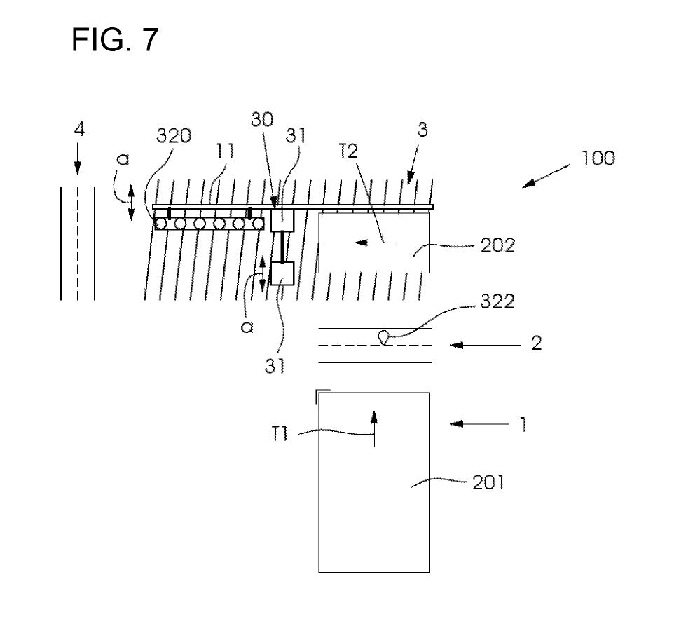

FIG. 7 illustrates a folding machine 100 with an adhesive-applying device 322 provided in its first buckle-folding station 2. Adhesive is applied to sheet parts, during folding, by the adhesive-applying device 322. Even after the folds have been removed by the trimming device 30, the individual sheets which are then present are still connected to one another by the adhesive, which simplifies the following transportation and processing.

1. A folding machine for folding sheet-shaped elements, the folding machine comprising:
at least a first buckle-folding station and a downstream second folding station each forming a respective folding configuration having at least one fold; and
a folded edge trimming device disposed upstream of said second folding station, in a transporting direction of the sheet-shaped elements, for removing at least one previously-formed fold.

2. The folding machine according to claim 1, wherein said second folding station is a buckle-folding station.

3. The folding machine according to claim 1, which further comprises:
at least one further folding station for forming a folding configuration having at least one fold; and
at least one further folded edge trimming device disposed upstream of said at least one further folding station for removing at least one previously-formed fold.

4. The folding machine according to claim 3, wherein said at least one further folding station is a buckle-folding station.

5. The folding machine according to claim 3, wherein each of said folded edge trimming devices has at least one respective trimming mechanism.

6. The folding machine according to claim 5, wherein said at least one trimming mechanism is configured to be displaced transversely to the transporting direction of the sheet-shaped elements.

7. The folding machine according to claim 1, wherein said folded edge trimming device has a fixing device for defined transportation of the sheet-shaped elements during removal of the at least one previously-formed fold and during feeding of the sheet-shaped elements to a downstream folding station.

8. The folding machine according to claim 1, which further comprises a suction-extraction device for removing portions of the sheet-shaped elements generated by said folded edge trimming device.

9. The folding machine according to claim 2, wherein at least one of said buckle-folding stations have folders and servomotors for adjusting folding lengths and spacings between said folders.

10. A method of folding sheet-shaped elements of a first format, the method comprising the following steps:
a) generating a first folded product by forming a folding configuration having at least one fold in a first buckle-folding station;
b) removing the at least one fold to form a stack of sheet-shaped elements of a second format;
c) transporting the stack of sheet-shaped elements further to a second folding station; and
d) generating a second folded product in the second folding station by forming a folding configuration having at least one second fold being orthogonal to the at least one fold generated in the first buckle-folding station.

11. The method of folding sheet-shaped elements according to claim 10, which further comprises providing the second folding station as a buckle-folding station.

12. The method of folding sheet-shaped elements according to claim 10, which further comprises the following additional steps:
e) removing at least one previously-formed fold for forming a stack of sheet-shaped elements of a further, smaller format;
f) transporting the stack of sheet-shaped elements further to at least one further folding station; and
g) generating a further folded product in the at least one further folding station by forming a folding configuration having at least one fold being orthogonal to the at least one fold generated in the second folding station.

13. The method of folding sheet-shaped elements according to claim 12, which further comprises providing the at least one further folding station as a buckle-folding station.

14. The method of folding sheet-shaped elements according to claim 10, which further comprises carrying out the method with a folding machine according to claim 1.
